(19) United States
(12) Patent Application Publication
(10) Pub. No.: US 2026/0331117 A1
(43) Pub. Date: Oct. 22, 2026

(54) AUDIO CLARITY IN MULTIPLE MICROPHONE COMMUNICATION SESSIONS

(71) Applicant: QUALCOMM Incorporated, San Diego, CA (US)

(72) Inventors: Kiran Anil CHIKODI, Belagavi (IN); Ashray Venkittan ACHARY, Hyderabad (IN); Pankaj MULCHANDANI, Raipur (IN); Swathi Durga DULAM, Hyderabad (IN); Chinna Lakshman PARA, Hyderabad (IN); Varada Mohan Reddy NANDYALA, Hyderabad (IN)

(21) Appl. No.: 19/185,179

(22) Filed: Apr. 21, 2025

(51) Int. Cl. G10L 21/02; H04R 3/00; G10L 17/06

(52) U.S. Cl. CPC G10L 21/02; H04R 3/005; G10L 17/06; H04R 2410/01; H04R 2430/01

(57) ABSTRACT

This disclosure provides methods, components, devices, and systems for selecting and adjusting microphone sensitivity in multi-device communication sessions using amplitude-based selection and speaker recognition. Some aspects more specifically relate to managing microphone access among participating devices in a communication session by analyzing microphone amplitude levels and speaker recognition confidence scores to determine optimal audio transmission. In some aspects, microphone sensitivity is adjusted based on real-time voice activity and speaker identification to enhance speech clarity while minimizing cross-talk and unintended background noise. In some aspects, participating devices operate in a centralized configuration, where a centralized microphone management module aggregates microphone-related information and applies predefined rules to coordinate microphone selection across participating devices. In some aspects, participating devices operate in a decentralized configuration, independently determining microphone priority based on shared microphone-related information.

### TECHNICAL FIELD

This disclosure relates generally to communication sessions and, more specifically, to provide optimal microphone selection between participating devices in a communication session using amplitude-based selection and speaker recognition to select the microphone.

### DESCRIPTION OF THE RELATED TECHNOLOGY

Wireless communication networks may include various types of wireless communication devices, including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols, or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a computing device. The computing device includes a processing system that includes one or more processors and one or more memories coupled with the one or more processors, the processing system configured to cause the computing device to receive a communication session identifier from other devices in a trusted environment, receive microphone-related information from the other devices having the communication session identifier in the trusted environment, and grant an audio channel access to a device of the other devices based on the microphone-related information. In some examples, the techniques described herein relate to the computing device, where the processing system is further configured to cause the computing device to receive the microphone-related information including a voice recognition percentage from at least one of the other devices, and grant the audio channel access to the device based on the microphone-related information including the voice recognition percentage.

In some examples, the techniques described herein relate to the computing device , where the processing system is further configured to cause the computing device to provide a request to at least one of the other devices to reduce a microphone sensitivity based on the microphone-related information associated with the at least one of the other devices being below a threshold.

Another innovative aspect of the subject matter described in this disclosure can be implemented in a computing device. The computing device includes a processing system that includes one or more processors and one or more memories coupled with the one or more processors, the processing system configured to cause the computing device to provide a communication session identifier to one or more devices in a trusted environment, receive microphone-related information from the one or more devices with the same communication session identifier, adjust a microphone sensitivity of the computing device based on the microphone-related information, and enable coordinated access among the one or more devices based on the microphone sensitivity.

In some examples, the techniques described herein relate to the computing device, where the processing system is further configured to cause the computing device to apply an attenuation that prevents audio transmission when internal microphone-related information associated with the computing device is below a threshold level, and increase the attenuation when the one or more devices causes an increase in the internal microphone-related information while providing audio.

In some examples, the techniques described herein relate to the computing device, where the processing system is further configured to cause the computing device to receive the microphone-related information including a voice recognition percentage associated with the one or more devices, where the recognition percentage indicates a confidence score associated with speech known to the computing device, and adjust the microphone sensitivity based on the microphone-related information including the voice recognition percentage.

Another innovative aspect of the subject matter described in this disclosure can be implemented in a computing device or application client device. The application client device includes one or more processors and one or more memories coupled with the one or more processors, the processing system configured to cause the application client device to receive a communication session identifier from other devices in a trusted environment, receive microphone-related information from the other devices having the communication session identifier in the trusted environment, and grant an audio channel access to a device of the other devices based on the microphone-related information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of an example trusted environment for providing secure communications between participating wireless communication devices.

FIG. 3 shows a pictorial diagram of an example decentralized communication session between wireless communication devices.

FIG. 4 shows a pictorial diagram of a n example centralized communication session between wireless communication devices.

FIG. 5 shows a pictorial diagram of an example wireless communication system with traffic flow between wireless communication devices participating in a communication session.

FIG. 6 shows an example microphone-amplitude array table of example microphone-related information of devices participating in a communication sessions and stored in a database.

FIG. 7 shows an example flowchart illustrating an example process performable by or at a wireless communication device that supports microphone selection between participating devices in a decentralized communication session.

FIG. 8 shows an example flowchart illustrating an example process performable by or at a wireless communication device that supports adjustment of microphone selection between participating devices in a communication session.

FIG. 9 shows an example flowchart illustrating an example process performable by or at a wireless communication device that support microphone selection between participating devices in a centralized communication session.

FIG. 10 shows an example block diagram of an example wireless communication device that supports microphone selection between participating devices in a communication session.

FIG. 11 shows an example flowchart illustrating an example process performable by or at a wireless communication device that support microphone selection between participating devices in a decentralized communication session.

FIG. 12 shows an example flowchart illustrating an example process performable by or at a wireless communication device that support microphone selection between participating devices in a centralized communication session.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate to enhancing meeting audio clarity in multi-microphone environments and, more particularly, to dynamically prioritizing microphone selection for audio transmission during a communication session. Some aspects, more specifically, relate to leveraging a trusted environment to coordinate microphone selection among multiple devices in a communication session. In some examples, a computing device in the trusted environment receives microphone-related information, such as microphone amplitudes from other devices in the trusted environment participating in the communication session. In some examples, the microphone-related information includes voice recognition percentages from the other devices. The voice recognition percentages can indicate a confidence score associated with recognized speech known to each of the other devices. Based on the microphone-related information, the computing device adjusts its microphone sensitivity. For example, the microphone-related information can show which device has the highest amplitude, indicating a close proximity to a speaker. Other computing devices in the meeting can adjust their microphone sensitivity to allow the computing device capturing the highest amplitude to transmit its audio. In some examples, the computing device factors in the voice recognition percentage, including the microphone amplitudes. Based on the voice recognition percentage and the microphone amplitudes, the computing device can adjust its sensitivity such that the computing device with the highest amplitude and highest voice recognition percentage is able to transmit its audio.

In some aspects, the computing device in the trusted environment receives microphone amplitudes from other devices in the trusted environment and participating in a communication session. In some examples, the computing device applies a channel access rule, prioritizing devices with the highest detected amplitude and voice recognition accuracy while dynamically adjusting sensitivity for overlapping speech scenarios. The computing device receives microphone-related information, including microphone amplitudes and voice recognition percentages from other devices in the trusted environment. As the microphone-related information is received, the computing device updates an internal microphone amplitude array that reflects the microphone amplitudes and voice recognition percentages. Based on the channel access rule, the computing device can be configured to grant audio channel access to one of the devices and restrict audio transmission from the other devices.

Particular aspects of the subject matter described in this disclosure can be implemented to realize one or more of the following potential advantages. The proposed decentralized and centralized microphone selection methods improve meeting audio quality by dynamically selecting the most appropriate microphone while suppressing unwanted background noise and cross-talk. By leveraging multi-device communication over a trusted environment, some aspects of the present disclosure allow seamless coordination of microphone access without requiring manual intervention from users. In some aspects, a decentralized microphone selection approach ensures real-time microphone selection adjustments based on voice amplitude and speaker recognition, minimizing latency and improving audio clarity. Additionally, the ability of devices to autonomously update and share microphone states provides a scalable solution for communication sessions with changing participants. In some other aspects, a centralized microphone selection approach optimizes microphone selection through a cloud-based or hub-controlled decision process, ensuring that only the clearest and most prominent audio is transmitted. This approach is particularly advantageous in large meetings or hybrid conference settings where a centralized entity can make informed microphone access decisions.

Furthermore, aspects of the present disclosure may improve overall meeting engagement by eliminating the need for users to manually enable or disable their microphones, reducing interruptions, and ensuring that speech from distant participants remains intelligible. By leveraging voice recognition techniques and amplitude-based prioritization, the disclosure enhances collaboration, minimizes disruptions, and provides a more natural and efficient meeting experience.

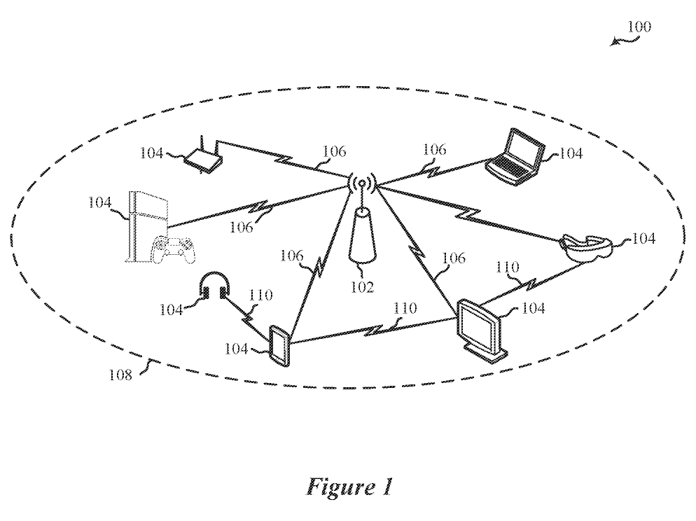

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network’s core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”), including the BSSID, to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS), including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network, such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or, the STAs 104, or both may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network, enabling communication with the two or more peripheral devices. Additionally, the AP 102 and STAs 104 may support additional ULL applications, such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control, and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of the spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz – 7.125 GHz), FR2 (24.25 GHz – 52.6 GHz), FR3 (7.125 GHz – 24.25 GHz), FR4a or FR4-1 (52.6 GHz – 71 GHz), FR4 (52.6 GHz – 114.25 GHz), and FR5 (114.25 GHz – 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be, and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend, and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel, and one or more additional second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices, and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some processes, methods, operations, techniques, or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. For example, an AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent of signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

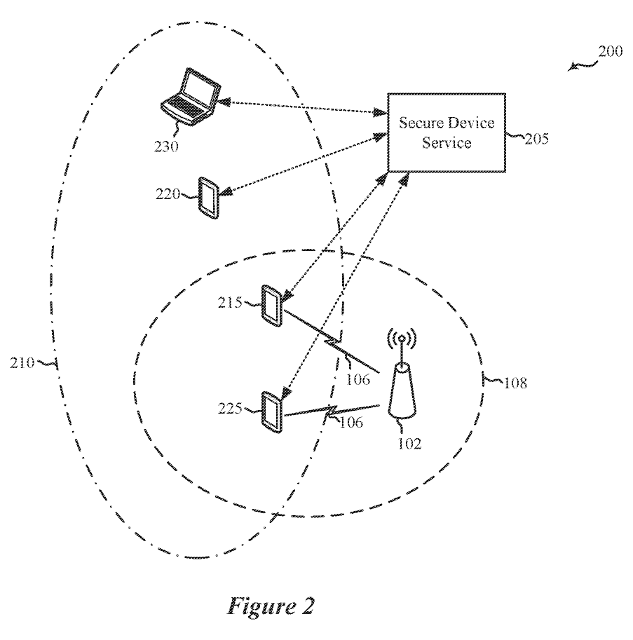

FIG. 2 shows an example pictorial diagram of an example of a trusted environment 200. In some examples, the trusted environment 200 includes secure devices or STAs (Stations) designated as trusted devices, which include secure stations such as STA 215, STA 220, STA 225, and STA 230. The STAs 215–230 participate in a distributed secure communication framework, allowing multi-device interaction across different network boundaries. In some examples, the distributed communication framework is a Dynamic Context Framework, or Distributed Context Fabriq, (DCF)-enabled multi-device network.

In this implementation, the trusted environment 200 facilitates real-time discovery, authentication, and adaptive communication between STAs 215-230 and other network entities. The STAs 215 and 225, located within the coverage area 108, establish communication with the AP 102 via secure communication links 106. In some examples, the secure communication links 106 utilize DCF-enabled protocols for encrypted data exchange.

Beyond the coverage area 108, the STAs 220 and 230 remain part of the trusted environment 200 across an alternative wireless network, including Wi-Fi, cellular, and IoT-based protocols. The STAs 220 and 230 maintain communication with the secure device service 205, which acts as a centralized or distributed hub managing device authentication, access policies, and encrypted data exchange.

In some examples, the distributed communication framework allows the STAs 215-230 to maintain persistent and adaptive connectivity via the communication links 110. Through secure or encrypted transmissions, communication within the trusted environment 200 is safeguarded using security keys, encrypted protocol data units (PDUs), and dynamic encryption negotiation techniques.

In some examples, the STAs 215–230 are similar to the STAs 104. For some examples, the STAs 215 and 225 may be located in the coverage area 108 and communicate with the AP 102 via communication links 106 as described in further detail in relation to FIG. 1. In some examples, the trusted devices also may include devices outside of a coverage area 108, such as the STA 220 and 230. For example, the STA 220 and 230 may communicate with the secure device service 205 via another wireless network, such as a Wi-Fi, cellular, IoT, or other wireless network. In some examples, the STAs 215-230 also may communicate via communication links 110 also described with reference to FIG. 1. In some examples, communications between the STAs 215-230 and the AP 102, secure device service 205, or directly between respective STAs include secure or encrypted communications in the trusted environment 200. For example, the STAs may communicate using secured wireless communication utilizing a security key and an encrypted protocol data unit (PDU).

In some examples, the STAs 215–230 are authenticated to a multi-device identification service and registered to secure device service 205 and include a unique identification installed on a respective STA indicating the STA is associated with other devices, including other devices in the trusted environment 200. In some examples, the secure device service 205 is executed on a network device such as a server, AP, such as the AP 102, or other network device in communication with the STAs 215–230.

In some examples, the STAs 215-230 are authenticated using a multi-device identification service and registered with the secure device service 205. The registration process provides that the STAs 215-230 are uniquely identified and cryptographically associated with other trusted devices within the trusted environment 200. The secure device service 205 can operate as a policy enforcement and coordination layer, which may be hosted on network infrastructure devices such as an access point (AP 102), an edge computing server, or a cloud-based orchestration system.

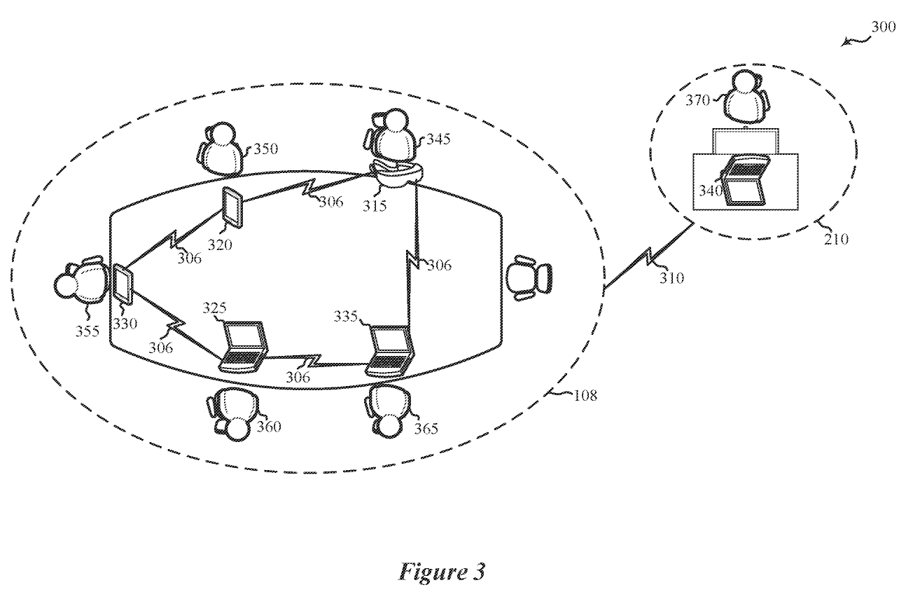

FIG. 3 shows an example pictorial diagram of a communication session 300 representing a video conference meeting in a conference room setup. In this implementation, multiple participants 345, 350, 355, 360, 365, are seated around a conference table within a designated coverage area 108, engaging in a collaborative meeting session. The participants utilize a combination of laptops, tablets, and other communication devices 315, 320, 325, 330, 335, 340 to interact in the session. In some examples, the communication devices 315, 320, 325, 330, 335, 340 are similar to the STAs 104.

The communication devices 315, 320, 325, 330, 335, 340 participating in the communication session 300 generate and share a communication session identifier that uniquely identifies them as part of the communication session 300. This session identifier can be dynamically assigned by a secure device service or pre-established through a meeting invitation system, ensuring that only authorized devices can join the session. The communication devices 315, 320, 325, 330, 335, 340 within coverage area 108 can detect each other using a secure broadcast mechanism over Wi-Fi, Bluetooth Low Energy (BLE), or another proximity-based protocol. They authenticate with the meeting session ID to confirm their participation and establish encrypted communication channels.

In some implementations, the communication devices 315, 320, 325, 330, 335, 340 are interconnected using a trusted environment, facilitating device communication within the coverage area 108. Using the secure transmission functionality of the trusted environment, the communication devices 315, 320, 325, 330, 335, 340 can manage audio streams to optimize meeting clarity, selecting the microphone and speaker configurations using a microphone-amplitude array or an AI-assisted voice processing mechanism.

In some examples, a remote participant 370, located within coverage area 210 is actively engaged in the session via a secure external link 310, connected to the communication device 340. The communication link between the remote participant 370 and the conference room leverages secure encrypted transmissions, allowing the remote participant to 370 provide the communication session identifier to identify them as part of the communication session 300. In some implementations, the communication device 370 is also part of the trusted environment with the other communication devices 315, 320, 325, 330, 335, 340. Using the secure transmission functionality of the trusted environment, the communication device 340 can select microphone and speaker configurations using a microphone-amplitude array or an AI-assisted voice processing mechanism.

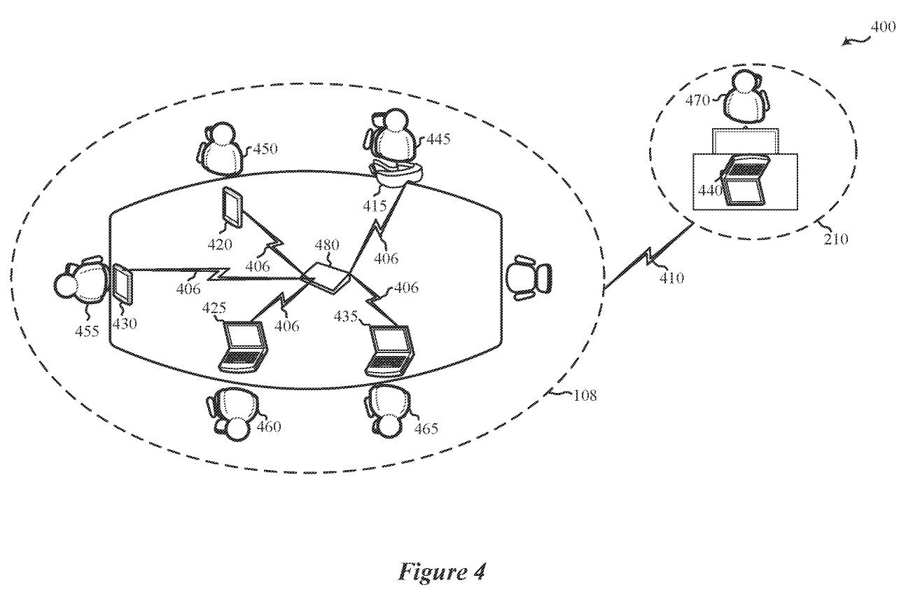

FIG. 4 shows an example pictorial diagram of a communication session 400, representing a video conference meeting in a smart conference room setup. In this implementation, multiple participants 445, 450, 455, 460, 465 are seated around a conference table within a designated coverage area 108, engaging in a collaborative, multi-device meeting session. The participants utilize a combination of laptops, tablets, and other communication devices 415, 420, 425, 430, 435, 440 to interact in the session. In some examples, the communication devices 415, 420, 425, 430, 435, 440 function in a similar fashion as STAs 104.

The communication devices 415, 420, 425, 430, 435, 440 participating in the communication session 400 generate and share a communication session identifier that uniquely identifies them as part of the meeting. This session identifier can be assigned by a secure device service or pre-established through a meeting invitation system, ensuring that only authorized devices can join the session. The communication devices 415, 420, 425, 430, 435 within coverage area 108 can automatically detect each other using a secure broadcast mechanism over Wi-Fi, Bluetooth Low Energy (BLE), or another proximity-based protocol. Each device undergoes authentication using the communication session identifier, confirming participation and establishing encrypted communication channels to secure the meeting.

In some implementations, the communication devices 415, 420, 425, 430, 435 operate within a trusted environment, facilitating secure multi-device communication within coverage area 108. The conference room hub 480 serves as the central coordination point, managing secure transmissions and synchronizing audio and video data streams among participants. Using the secure transmission functionality of the trusted environment, the communication devices 415, 420, 425, 430, 435, 440 can dynamically manage audio streams to optimize meeting clarity, selecting microphone and speaker configurations via a microphone-amplitude array or an AI-assisted voice processing mechanism. This mechanism provides low-latency speech recognition, automatic noise suppression, and adaptive microphone selection to prevent cross-talk or interference.

In some examples, a remote participant 470, located in coverage area 210, is actively engaged in the session via a secure external link 410, connected to the communication device 440. The communication link between the remote participant 470 and the conference room can utilize end-to-end encrypted transmissions, ensuring data integrity and confidentiality. The remote participant can also provide the communication session identifier, verifying their authorization to join the communication session 400.

In some implementations, the remote communication device 470 is also part of the trusted environment, allowing it to integrate with the other communication devices 415, 420, 425, 430, 435. Through the secure transmission functionality of the trusted environment, the remote communication device 470 can select microphone and speaker configurations using a microphone-amplitude array or an AI-assisted voice processing mechanism.

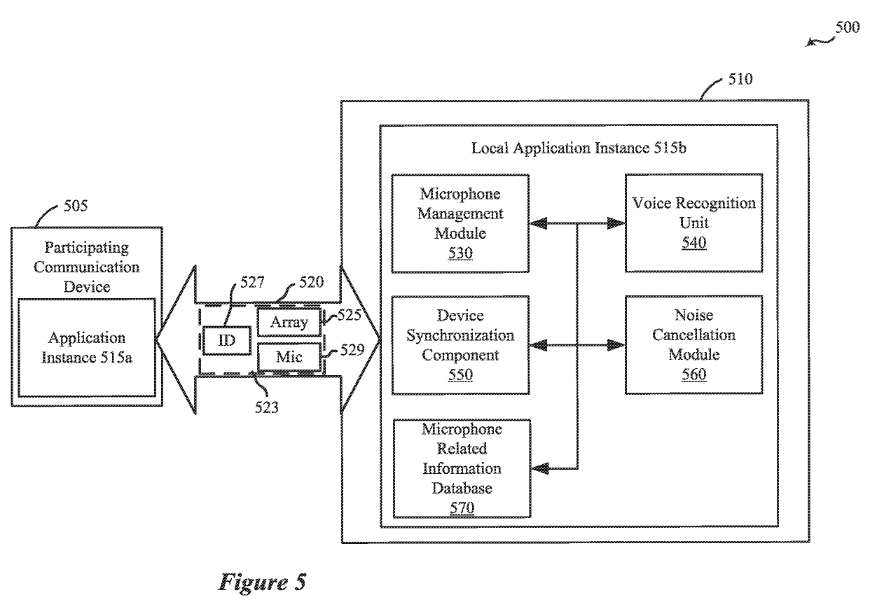

FIG. 5 shows an example pictorial diagram of an example wireless communication system 500 for providing optimal microphone selection among multiple nearby devices using microphone amplitude-based selection and speaker recognition. In some examples, the wireless communication system 500 includes a wireless communication device 510 in a network such as the wireless communication network 100 described with reference to FIG. 1, operating within a trusted environment 200 described with reference to FIG. 2, and in a communication session 300 or 400 described with reference to FIGS. 3 and 4. The wireless communication device 510 can be configurable or configured for use in an AP, such as the AP 102 described with reference to FIG. 1. In some examples, the wireless communication device 510 can also be configurable or configured for use in a STA, such as the STA 104 described with reference to FIG. 1. The wireless communication device 510 also may be a server, a distributed device, or a cloud-based server where the components of the wireless communication device 510 described herein are distributed as cloud-based modules, services or applications.

For example, the wireless communication system includes a communication session application 515 (shown as application instance 515a on the participating communication device 505 and local application instance 515b on the wireless communication device 510) that provides a traffic flow 520 to a microphone management module 530 for managing microphone selection and operation during a communication session between devices. In some examples, the application instance 515a provides the traffic flow 520 over a network connection, such as a Wi-Fi connection or other similar connection, to the wireless communication device 510. In some examples, the local application instance 515b on the wireless communication device 510 directly provides the traffic flow 520 to the microphone management module 530.

In some examples, the communication session application 515 is latency-sensitive communication session software designed for seamless multi-device conferencing and collaboration. For example, communication session application 515 may be a video conferencing application, voice communication application, or similar application/service. In some examples, communication session application 515 operates on a multi-microphone and multi-device-enabled communication platform with trusted devices dynamically discovering each other, authenticating securely, and transmitting communications with other trusted devices. The communication session application 515 operates across various device types, including conference room systems, smartphones, tablets, computers, and AR/VR devices. Users interact with the application interface, where voice and video streams are continuously updated from remote servers, cloud processing units, and other user devices running the communication session application 515.

In some examples, the communication session application 515 operates on a centralized processing hub or cloud-based server that manages microphone selection, voice amplitude ranking, and speaker transitions across the participating devices in the communication session. The communication session application 515 can leverage the trusted environment to provide secure and encrypted communication, using security keys and encrypted PDUs to safeguard real-time transmissions. A secure device service associated with the communication session application 515 can register participating devices and associate them cryptographically within the trusted environment. The secure device service can enforce access policies and dynamically manage communication links in a multi-device, multi-user communication session.

In some examples, communication session application 515 creates or initiates a traffic flow 520 of communication data. During a communication session, the communication session application 515 can adjust audio signals, video data, microphone control data, user interaction data, and noise-cancellation signals and transmit those signals between devices. In some examples, the communication session application 515 may establish the communication session using a session identifier 527, such as a unique token or ID used to authenticate and track attendees in the communication session. The session identifier may be a cryptographic token or a unique numeric or alphanumeric code assigned to the communication session provided to others.

In some examples during the communication session, the communication session application 515 may establish separate traffic flows for signaling data, real-time voice and video transmission, and microphone selection control during a communication session. The communication session application 515 may use Hypertext Transfer Protocol (HTTP) and Internet Control Message Protocol (ICMP) for signaling and controlling traffic while using Transmission Control Protocol (TCP) and User Datagram Protocol (UDP) for real-time audio and video streaming.

In some examples, the communication session application 515 implements a device synchronization component 550 that utilizes a random-access timer (RA Timer) to manage device synchronization and prevent simultaneous access collisions when devices, such as the participating communication device 505, attempt to join the communication session. When a device seeks to participate in the communication session, it can broadcast the session identifier 527 over the trusted environment 200 signaling channel. The RA Timer ensures that devices do not provide their join requests simultaneously to minimize packet collisions.

In some examples, devices that detect an ongoing session identifier broadcast can halt their RA Timer and join the temporary trusted environment upon successful acknowledgment. This process can update a device list, enabling the discovery and integration of new devices into the communication session. By employing a structured, time-based arbitration mechanism, the communication session application 515 allows the traffic flow 520, including microphone-related information, to be updated with participating devices contributing microphone-related information.

In some examples, the microphone management module 530 processes the microphone-related information provided from the participating device 505 and other participating devices and updates an internal microphone-amplitude array. The microphone-amplitude array can be used to select an optimal microphone for audio transmission during the communication session. Each participating device in the communication session can continuously measure its microphone’s amplitude level and transmit this and other microphone-related information, including its device ID and microphone ID, to the other participating communication devices. The microphone management module 530 compiles these values into the microphone-amplitude array, which maintains a real-time ranking of active microphones based on amplitude strength and speaker recognition accuracy.

During the communication session, the microphone-amplitude array is continuously updated to reflect real-time speaking activity across participating devices. The microphone management module 530 monitors amplitude fluctuations and adjusts microphone priority based on detected changes. When a device begins transmitting at a higher amplitude level, its position in the microphone-amplitude array is updated, and the communication device attenuates or disables lower-priority microphones to prevent crosstalk and overlapping audio.

In a decentralized communication session, each device maintains a local copy of the microphone-amplitude array, broadcasting microphone-related information updates at predefined intervals to the other participating devices in the communication session. Devices independently determine the best microphone selection based on real-time amplitude rankings. In a centralized communication session, the microphone management module 530 aggregates microphone-related information from the participating devices and makes a global selection decision based on predefined rules, including voice recognition accuracy and noise suppression requirements. A non-limiting example of a predefined rule is a channel access rule, where a device with stronger voice amplitude and more accurate voice recognition is granted channel access.

In some examples, the microphone management module 530 applies filtering techniques to enhance microphone selection accuracy. When two or more devices report similar amplitude levels, the communication session application 515 prioritizes the microphone with the highest voice recognition accuracy for the active speaker. The microphone management module 530 can also apply a hysteresis timer to prevent rapid switching between microphones due to minor amplitude fluctuations, maintaining audio transmission stability.

In some examples, a voice recognition unit 540 enhances microphone selection and speech clarity by identifying active speakers captured during a communication session. The voice recognition unit 540 can work in conjunction with the microphone management module 530 and the microphone-amplitude array to prioritize microphones based on speaker identity and confidence levels. Using pre-trained speaker models, the voice recognition unit 540 can continuously analyze incoming voice data and assign a voice recognition accuracy score to determine how closely the detected speech matches a registered speaker profile associated with the communication device 510.

During a communication session, each participating device captures voice data and processes it through its local voice recognition unit. The device compares the detected voice features, such as pitch, tone, and speech patterns, against its stored voice models and generates a real-time confidence score. This score is transmitted alongside the microphone amplitude level to the other devices in the communication session, enabling microphone selection based on speaker identity and audio quality.

In some examples, the voice recognition unit 540 filters unintended voices and prevents unauthorized audio transmission. If a device captures audio but the recognition accuracy falls below a predefined attenuation threshold, the voice recognition unit 540 may attenuate or completely disable that transmission to avoid disruptions from background conversations or unintended speakers. In a centralized communication session, the voice recognition accuracy scores are aggregated, and the voice recognition unit 540 ensures that microphones associated with highly recognized speakers are given priority.

In a decentralized communication session, each device maintains a local decision-making process for voice recognition and microphone selection. Devices continuously compare their voice recognition scores and amplitude levels against those reported by other devices via the microphone-amplitude array. If a device detects that another microphone has a higher confidence score for an active speaker, it can automatically reduce its microphone sensitivity to prevent overlapping transmissions.

In some examples, the voice recognition unit 540 improves noise suppression by distinguishing between speech and background noise sources. By cross-referencing voice patterns against trained speaker models, the voice recognition unit 540 prioritizes human speech. At the same time, non-speech audio, such as keyboard typing, background chatter, or environmental noise, is suppressed.

In some examples, a noise cancellation module 560 enhances speech clarity by applying active noise cancellation (ANC) techniques to reduce background noise and prevent unwanted audio interference during a communication session. The noise cancellation module 560 operates alongside the microphone management module 530 to selectively filter out non-speech sounds while preserving the speaker’s voice. The noise cancellation module 560 can continuously analyze the incoming audio signals from multiple devices and apply adaptive filtering algorithms to isolate the primary speaker's voice while suppressing ambient noise.

In some examples, the noise cancellation module 560 integrates ANC methods, including beamforming, spectral subtraction, and machine learning-based noise filtering. Beamforming leverages multiple microphone inputs to create a directional audio focus, allowing signals originating from the primary speaker to be enhanced while unwanted noise from other directions is attenuated. Spectral subtraction dynamically analyzes frequency components in the captured audio and removes noise frequencies that do not align with human speech patterns. In some examples, AI-based noise suppression models are trained to distinguish between speech and non-speech sounds, allowing real-time adaptation to various acoustic environments.

During a communication session, the noise cancellation module 560 collaborates with the microphone management module 530 to refine microphone selection based on noise levels. If a selected microphone detects excessive background noise, the microphone management module 530 may switch to an alternative microphone with a higher signal-to-noise ratio (SNR). In some examples, the microphone-amplitude array is updated in real-time to reflect noise levels, allowing for dynamic adjustments to microphone sensitivity and selection.

In some examples of a communication session in a multi-microphone setup, the noise cancellation module 560 synchronizes ANC across participating devices to maintain consistent audio quality. Each device applies local noise suppression based on its captured environment, while a centralized communication device, if present, restricts residual noise artifacts across the communication session. The noise cancellation module 560 can also leverage far-field voice detection techniques to isolate speech from distant users while mitigating background disturbances.

In some examples, the noise cancellation module 560 applies a noise gating mechanism. The gating mechanism analyzes the amplitude and frequency characteristics of the captured audio and compares them to a predefined attenuation threshold to determine whether a microphone should remain active. The microphones detecting audio below the predefined attenuation threshold, such as ambient noise or non-speech signals, can be gradually attenuated or deactivated to reduce background noise. When a user stops speaking, the noise cancellation module 560 gradually lowers the microphone’s sensitivity instead of abruptly cutting off the audio to prevent unintended audio disruptions.

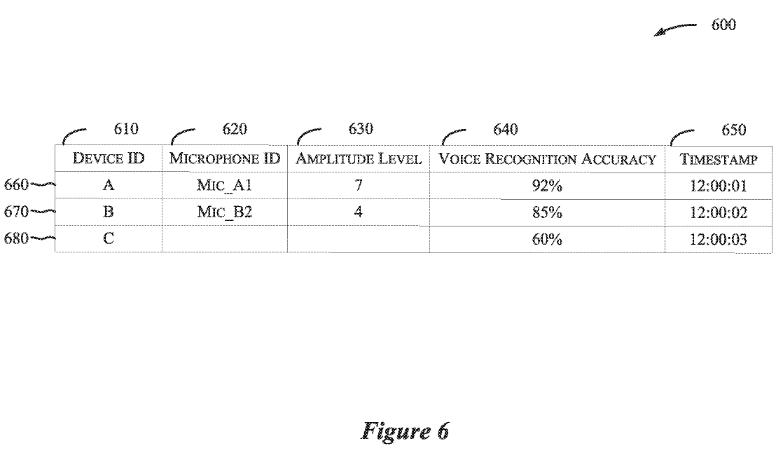

FIG. 6 shows an example table 600 of an example microphone-amplitude array storing microphone amplitude and voice recognition accuracy data during a communication session. In some examples, the table 600 includes columns 610–650 and rows 660–680 and is maintained by microphone management module 530 and used for microphone selection and voice clarity optimization. Each row represents a participating device and its associated microphone data.

The device ID column 610 identifies each participating device, while the microphone ID column 620 records the specific microphone in use on that device. The amplitude level column 630 stores the detected voice amplitude level for each device, representing how strongly the microphone picks up a user's speech during the communication session. The voice recognition accuracy column 640 contains the confidence percentage for speaker recognition provided by the voice recognition unit 540. The timestamp column 650 records the time when the data was captured, allowing synchronization and historical analysis.

In some examples, the microphone management module 530 or a centralized processing unit evaluates the microphone amplitude levels and voice recognition accuracy to determine the best microphone for transmission. If a device's amplitude level is higher and its voice recognition accuracy meets a speaking threshold, it is selected for active transmission. The device synchronization component 550 ensures that updates to the microphone selection are propagated to all participating devices. The stored information in the table 600 updates throughout the communication session, optimizing real-time audio clarity while reducing cross-talk and background noise.

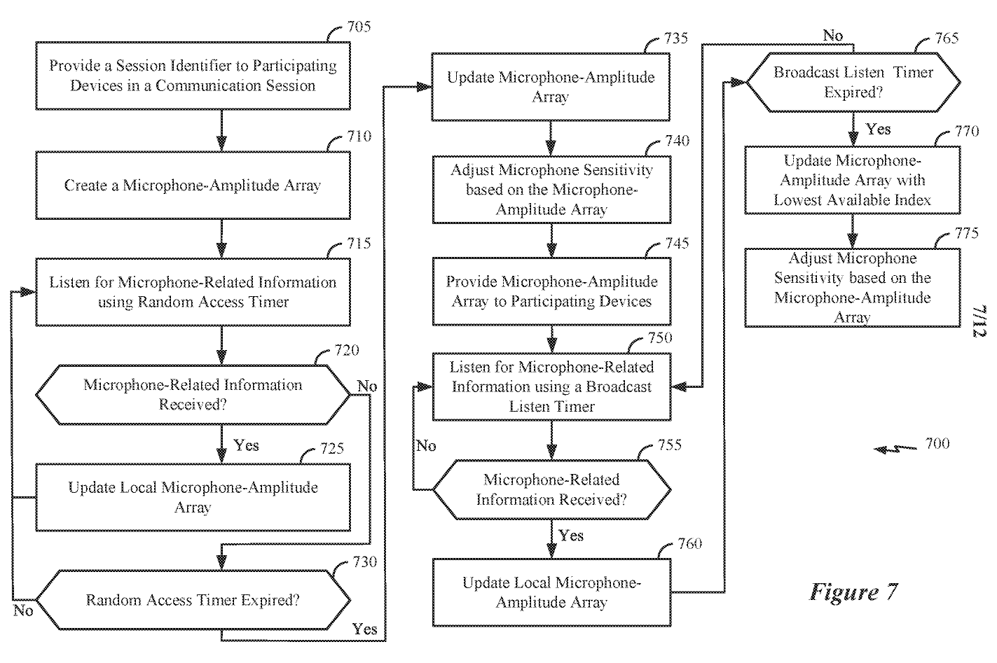

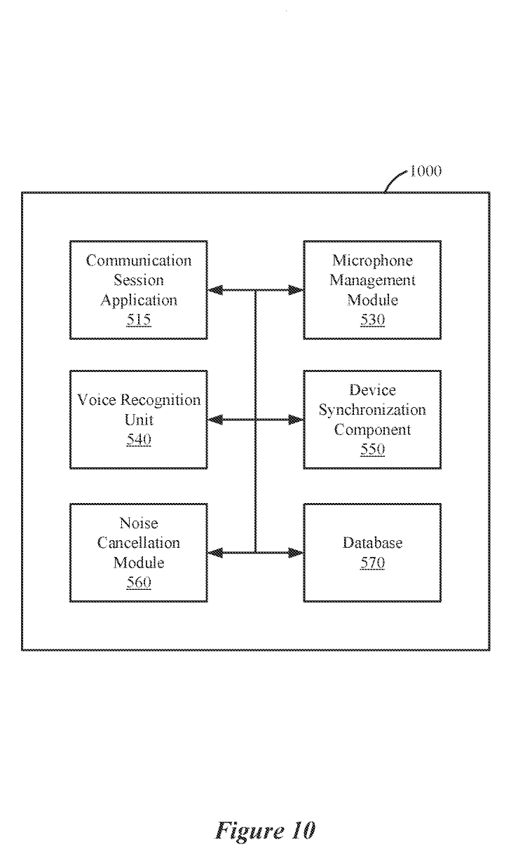

FIG. 7 illustrates an example flowchart depicting an example process 700 performable by or at a wireless communication device that supports dynamically managing microphone selection in a communication session. The operations of the process 700 may be implemented by a wireless communication device or its components as described herein. For example, the process 700 may be performed by a wireless communication device, such as the wireless communication device 1000 described with reference to FIG. 10, operating within a wireless AP, a wireless STA or other wireless communication device. In some examples, the process 700 may be performed by a wireless AP, such as one of the APs 102, or the wireless STA, such as one of the STAs 104 described with reference to FIG. 1. In some examples, the process 700 also may be performed by a wireless communication device such as the wireless communication device 510 with reference to FIG. 5.

In some examples, at block 705, the wireless communication device provides a session identifier to participating devices in a communication session. The session identifier establishes a secure communication session between the participating devices associated within a trusted environment. In some examples, an application such as the application instance 515 described with reference to FIG. 5 may provide the session identifier in a traffic flow 520 to a participating device 505. In some examples, the devices participating in the communication session authenticate and join the communication session by broadcasting their unique session identifiers. This can establish the devices available to contribute to the microphone selection during the communication session. Each device may maintain an updated microphone-amplitude array storing microphone-related information to track microphone sensitivity and voice recognition accuracy.

In some examples, at block 710, the wireless communication device creates a microphone-amplitude array to store real-time amplitude levels captured by each participating device. The microphone-amplitude array can be updated based on microphone input levels and speaker recognition confidence scores. The microphone-amplitude array may include the microphone input levels, the speaker recognition confidence score, or both.

In some examples, at block 715, the wireless communication device listens for microphone-related information from the participating devices. The microphone-related information may include voice amplitude levels, device IDs, and speaker recognition confidence scores. In some examples, the traffic flow 520 from application instance 515a contains microphone-related information provided to the application instance 515b. The wireless communication device may continuously monitor and update the microphone-amplitude array when the traffic flow from participating devices provides their respective microphone-related information.

In some examples, at block 720, the wireless communication device checks whether microphone-based information has been received from a participating device in the communication session. For example, the microphone management module 530 continuously monitors traffic flow 520 from participating devices to check for microphone-related updates. Each device, such as communication device 505, regularly provides its microphone-related information to allow for real-time synchronization. As an example, when a participant begins speaking, their device captures voice amplitude levels and provides the data to the microphone management module 530 for processing. In some instances, the voice recognition unit 540 analyzes the incoming voice data to verify if the speaker is recognized, assigning a confidence score to determine if their microphone should be prioritized. If no microphone-related information is received, the wireless communication device proceeds to block 730. If the wireless communication device receives microphone-related information, it proceeds to block 725.

In some examples, at block 725, the wireless communication device updates its local microphone-amplitude array upon receiving microphone-related information from a participating device. The microphone-amplitude array can serve as a continuously evolving database that ranks microphones based on how well they capture sound and whether the detected voices belong to a recognized speaker. For example, the microphone management module 530 processes the microphone-related information provided by the participating device 505 to determine a ranking. In some examples, processing the microphone-related information includes extracting voice amplitude levels, voice recognition scores, and device and microphone IDs from the traffic flow 520. The microphone management module 530 updates the microphone-amplitude array with the extracted information.

In some examples, at block 730, the wireless communication device checks whether the RA-Timer has expired. The RA-timer can prevent unnecessary or premature microphone-related information updates while allowing the wireless communication device to process new microphone-related information. If the RA-Timer has not expired, the wireless communication device continues monitoring for new microphone-related information without making immediate changes by returning to block 715. If the RA-Timer has expired, the wireless communication device proceeds to block 735 so it may re-evaluate the microphone selection process.

As an example, the device synchronization component 550 manages the RA-Timer. When microphone-related information is received, the microphone management module 530 processes the data and updates the microphone-amplitude array accordingly. However, to avoid frequent and unnecessary microphone switching, the RA-Timer imposes a delay before another update can be processed. When the RA-Timer expires, the device synchronization component 550 can signal the microphone management module 530 to proceed with a new microphone selection, if necessary.

In some examples, at block 735, the wireless communication device updates the microphone-amplitude array to reflect new microphone-related information received from the participating devices. Updating the microphone-amplitude array allows the wireless communication device to provide microphone selection and be responsive to changes in voice activity, background noise, and speaker recognition accuracy. As an example, the microphone management module 530 processes the microphone-related information and updates the internal microphone-amplitude array.

In some examples, at block 740, the wireless communication device adjusts its microphone sensitivity based on the microphone-amplitude array. The microphone sensitivity adjustment can modify the gain levels based on amplitude measurements and, in some examples, voice recognition accuracy. Adjusting the microphone sensitivity may also prevent over-amplification of distant sounds and background noise and enhance speech clarity.

In some examples, the microphone management module 530 implements the adjustment of the microphone sensitivity. As an example, when a device, such as communication device 505, is selected as the active microphone, its sensitivity may be increased or decreased depending on its proximity to the speaker and the background noise levels detected. If a microphone is too sensitive, it may pick up unwanted sounds, such as ambient noise or overlapping speech from other participants. Conversely, if a microphone’s sensitivity is too low, the speaker’s voice may not be adequately captured, leading to poor audio quality. The microphone management module 530 may adjust sensitivity levels to allow the speaker’s voice to be captured clearly and at an appropriate volume.

In some examples, the device synchronization component 550 manages the broadcast listen timer to regulate when the wireless communication device 510 listens for microphone-related information from participating devices. As an example, when the broadcast listen timer expires, the microphone management module 530 collects microphone-related information from participating devices, such as communication device 505, via traffic flow 520. The voice recognition unit 540 analyzes the received data to determine if a recognized speaker is actively speaking. If a participating device has a high amplitude but low speaker recognition confidence, it may be deprioritized in the microphone-amplitude array to reduce potential audio interference. Similarly, the noise cancellation module 560 evaluates the captured audio signals and filters out excessive background noise. Once the microphone-amplitude array is updated, the communication session application 515 provides the updated rankings to participating devices, allowing them to synchronize microphone selection dynamically.

In some examples, the voice recognition unit 540 assists in refining microphone sensitivity by analyzing whether the detected voice matches a recognized speaker profile. If the active microphone detects a high-amplitude voice but low recognition confidence, the microphone management module 530 may adjust the microphone’s sensitivity to filter out unintended voices. However, if a recognized speaker is detected but their voice is too faint, the system may increase microphone sensitivity to ensure their speech is clearly captured. The adjustment may prevent background voices or overlapping conversations from interfering with the primary speaker’s audio transmission.

In some examples, the noise cancellation module 560 refines the microphone sensitivity by applying active noise suppression techniques based on the updated microphone-amplitude array. As an example, if a microphone detects excessive background noise, the noise cancellation module 560 may reduce its sensitivity to suppress these distractions. Instances such as these may arise in multi-device communication sessions, where multiple microphones are active and work together during the communication session.

In some examples, at block 745, the wireless communication device provides the microphone-amplitude array to participating devices in the communication session. The microphone-amplitude array contains real-time amplitude levels and other microphone-related information collected from each participating device. By redistributing this array, the wireless communication device enables the participating devices to have synchronized information regarding microphone sensitivity levels, speaker recognition confidence, and background noise conditions. In some examples, the microphone-amplitude array is transmitted over a secure communication link in a trusted environment to prevent unauthorized access. The provided information allows participating devices to adjust their own microphone sensitivity and dynamically coordinate audio transmission to optimize clarity and minimize interference.

In some examples, the wireless communication device 510 provides the microphone-amplitude array to participating devices in a communication session to facilitate microphone selection across the communication session. The microphone management module 530 processes the microphone-related information, including voice amplitude levels and voice recognition accuracy, received from participating devices. Once the microphone-amplitude array is updated, the device synchronization component 550 coordinates the distribution of the array to the participating communication device 505 and other devices in the session.

The microphone-amplitude array is transmitted over the traffic flow 520, managed by the communication session application 515. The voice recognition unit 540 assists in verifying speaker identity within the array, allowing the participating devices to prioritize microphones with the highest speaker recognition confidence scores. In some examples, the noise cancellation module 560 may analyze the microphone-amplitude array to filter out microphones that detect excessive background noise, further refining the transmission of audio data.

Upon receiving the microphone amplitude array, each participating device can update its internal microphone selection parameters and adjust microphone sensitivity accordingly. The database 570 stores historical microphone-amplitude data, allowing the application 515 to track trends in microphone performance over time and optimize selection for future sessions.

In some examples, at block 750, the wireless communication device listens for microphone-related information from the participating devices using a broadcast listen timer. The microphone-related information. The broadcast listen timer allows the wireless communication device to periodically check for updates instead of continuously monitoring, optimizing resource usage while maintaining real-time responsiveness. In some examples, the traffic flow 520 from application instance 515a contains microphone-related information that is provided to the application instance 515b. The wireless communication device may continuously monitor and update the microphone-amplitude array when the traffic flow from participating devices provides their respective microphone-related information.

In some examples, at block 755, the wireless communication device 510 determines whether microphone-related information has been received from one or more participating devices. As an example, the microphone management module 530 continuously monitors traffic flow 520 for updates containing voice amplitude levels, device IDs, and speaker recognition confidence scores. When a participating device, such as communication device 505, transmits new microphone-related information, the wireless communication device 510 processes the received data and proceeds to block 760 to update the microphone-amplitude array. If no microphone-related information is received within the listening period, the wireless communication device returns to block 750, where the broadcast listen timer initiates a new cycle to listen for microphone-related data.

In some examples, at block 760, the wireless communication device 510 updates the microphone-amplitude array with the newly received microphone-related information from participating devices. The microphone management module 530 processes the incoming data to adjust the ranking of microphones in the array. As an example, if the communication device 505 transmits microphone-related information indicating an increased voice amplitude level and a high speaker recognition confidence score, its ranking in the microphone-amplitude array may be elevated to prioritize its microphone for audio transmission. Conversely, if a device reports low speaker recognition confidence or increased background noise, the noise cancellation module 560 may flag it for reduced priority in the array. Once the microphone-amplitude array is updated, the wireless communication device proceeds to the next step in the microphone selection process, allowing real-time adjustments to optimize speech clarity and minimize interference.

In some examples, at block 765, the wireless communication device determines whether the broadcast listen timer has expired. As an example, the device synchronization component 550 manages this timer to regulate when the wireless communication device 510 should listen for microphone-related information from participating devices. As an example, if the broadcast listen timer has not expired, the wireless communication device 510 returns to block 750, where it continues listening for microphone-related updates without making any changes. However, if the broadcast listen timer has expired, the wireless communication device 510 proceeds to block 770, initiating the next step in the microphone selection process.

In some examples, at block 770, the wireless communication device 510 updates the microphone-amplitude array with the lowest available index to maintain an ordered structure for microphone selection. As an example, the microphone management module 530 processes the newly received microphone-related information and assigns a ranking to each participating device based on at least one of the voice amplitude levels, speaker recognition confidence scores, and noise levels. As an example, if the communication device 505 reports a lower amplitude level compared to other devices, its microphone may be assigned a lower index in the array, deprioritizing it for selection. Conversely, if a device previously ranked low now reports higher voice amplitude and improved recognition confidence, it may be reassigned to a higher index to reflect its increased priority. In some examples, the voice recognition unit 540 assists in verifying speaker identity, allowing recognized speakers to be assigned optimal positions within the array.

In some examples, at block 775, the wireless communication device adjusts its microphone sensitivity based on the microphone-amplitude array. The microphone sensitivity adjustment can modify the gain levels based on amplitude measurements and, in some examples, voice recognition accuracy. Adjusting the microphone sensitivity may also prevent over-amplification of distant sounds and background noise and enhance speech clarity.

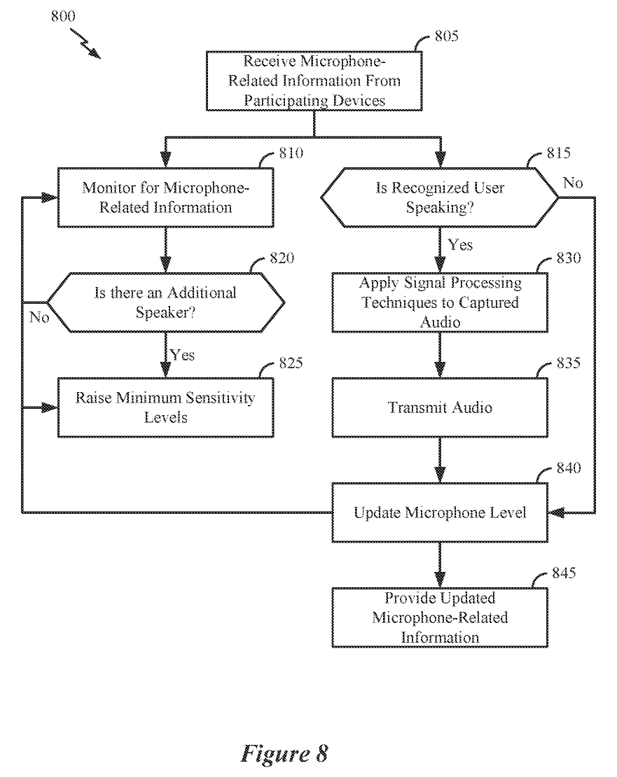

FIG. 8 illustrates an example flowchart depicting an example process 800 performable by or at a wireless communication device that supports dynamically managing microphone selection in a communication session. The operations of the process 800 may be implemented by a wireless communication device or its components as described herein. For example, the process 800 may be performed by a wireless communication device, such as the wireless communication device 1000 described with reference to FIG. 10, operating within a wireless AP, a wireless STA or other wireless communication device. In some examples, the process 800 may be performed by a wireless AP such as one of the APs 102 or the wireless STA such as one of the STAs 104 described with reference to FIG. 1. In some examples, the process 800 also may be performed by a wireless communication device such as the wireless communication device 510 with reference to FIG. 5.

In some examples, at block 805, the wireless communication device receives microphone-related information from participating devices. As an example, the microphone management module 530 processes amplitude levels detected at each microphone, confidence scores from the voice recognition unit 540, and noise levels analyzed by the noise cancellation module 560. The information is stored in the microphone-amplitude array, which ranks microphones based on their clarity and priority for transmission.

In some examples, at block 810, the wireless communication device monitors for microphone-related information from participating devices in the communication session. As an example, the microphone management module 530 continuously listens for updates from the participating devices, including changes in amplitude levels, voice recognition confidence scores from the voice recognition unit 540, and noise levels analyzed by the noise cancellation module 560. If a change in microphone-related information is detected, such as an increase in amplitude from another device or a shift in speaker recognition confidence, the wireless communication device can prepare to update microphone selection accordingly. If no new information is received, the wireless communication device continues monitoring while maintaining the current microphone selection.

At step 815, the wireless communication device determines whether a recognized user is speaking. As an example, the voice recognition unit 540 compares the captured voice signature against stored speaker models to determine if the active microphone belongs to a recognized participant. If a recognized speaker is identified, the wireless communication device proceeds to block 835. However, if the wireless communication device does not detect a recognized speaker, the wireless communication device proceeds to block 840. In some examples, if the confidence score surpasses a predefined threshold, the wireless communication device prioritizes that microphone for transmission. If the speaker is unrecognized or has a low confidence score, the microphone’s sensitivity is reduced or deprioritized to prevent unintended voice capture and mitigate interference from background noise.

In some examples, at block 820, the wireless communication device evaluates whether an additional speaker is detected in the communication session. If a new speaker is identified, the wireless communication device proceeds to block 825. However, if the wireless communication device does not detect a new speaker, the wireless communication device returns to block 810 and continues monitoring for microphone-related information from the participating devices.

In some examples, at block 825, the wireless communication device raises or lowers the minimum sensitivity levels of microphones to prevent overlapping speech capture and ensure smooth transitions between speakers. If a second speaker is detected, the wireless communication device can lower the inactive microphone’s sensitivity to prevent cross-talk. Conversely, if background noise levels are too high, the wireless communication device can raise the minimum sensitivity to avoid picking up unintended sounds.

In some examples, at block 830, the wireless communication device applies signal processing techniques to the captured audio. As an example, the noise cancellation module 560 enhances speech clarity through ANC, which filters out background noise, beamforming, which focuses on the primary speaker, automatic gain control AGC, which stabilizes audio levels, and spectral subtraction, which removes non-speech frequencies.

In some examples, at block 835 the wireless communication device enables the selected microphone to begin transmitting audio to the communication session. As an example, the microphone management module 530 verifies that only the prioritized microphone is actively transmitting while ensuring that other devices reduce their microphone sensitivity accordingly. This prevents multiple devices from transmitting at the same time and guarantees that the clearest audio is used.

In some examples, at block 840, the wireless communication device updates the microphone level based on newly received microphone-related information. As an example, the microphone management module 530 analyzes the latest amplitude data, voice recognition confidence scores, and background noise levels from the microphone amplitude array to determine whether microphone sensitivity adjustments are necessary. If a device’s microphone detects a significant change in amplitude or if a recognized speaker's confidence score increases, the wireless communication device recalibrates the microphone sensitivity to ensure optimal audio capture. The device synchronization component 550 can propagate these updates to the participating devices, maintaining synchronization across the communication session.

In some examples, at block 845, the wireless communication device provides updated microphone-related information to participating devices, allowing the participating devices to remain aware of the current microphone selection hierarchy.

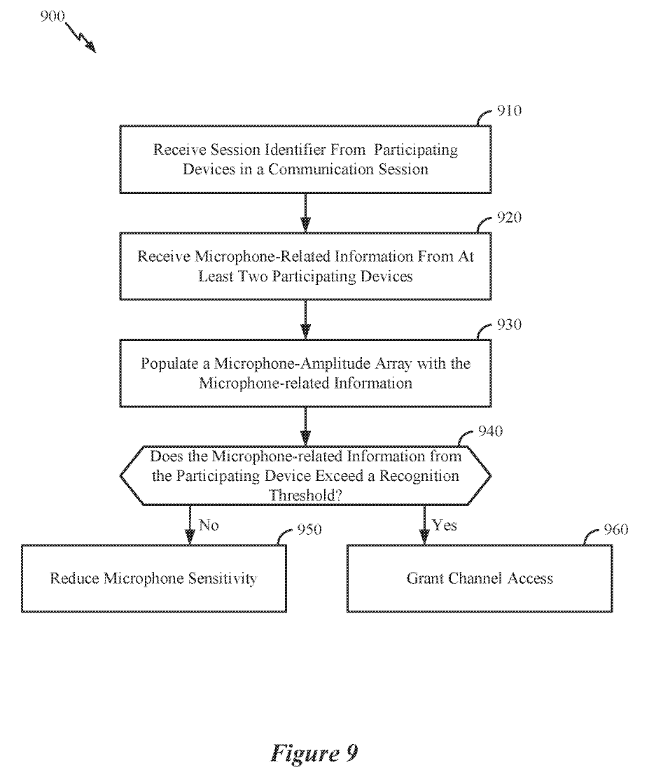

FIG. 9 illustrates an example flowchart depicting an example process 900 performable by or at a wireless communication device that supports dynamically managing microphone selection in a communication session. The operations of the process 900 may be implemented by a wireless communication device or its components as described herein. For example, the process 900 may be performed by a wireless communication device, such as the wireless communication device 1000 described with reference to FIG. 10, operating within a wireless AP, a wireless STA, or other wireless communication devices. In some examples, the process 900 may be performed by a wireless AP such as one of the APs 102 or the wireless STA such as one of the STAs 104 described with reference to FIG. 1. In some examples, the process 900 also may be performed by a wireless communication device such as the wireless communication device 510 with reference to FIG. 5.

In some examples, at block 910, the wireless communication device receives a session identifier from participating devices in a communication session. The session identifier establishes a secure communication session between participating devices in a trusted environment. In some examples, an application instance 515a on a participating device 505 transmits the session identifier over traffic flow 520 to the local application instance 515b on the wireless communication device 510. The participating devices authenticate and join the communication session by broadcasting their unique session identifiers to participate in the communication session.

In some examples, at block 920, the wireless communication device receives microphone-related information from at least two participating devices in the communication session. The microphone-related information may include voice amplitude levels, device IDs, and speaker recognition confidence scores. As an example, the microphone management module 530 continuously monitors traffic flow 520 for updates. When two or more participating devices transmit their microphone-related information, the wireless communication device 510 collects and processes the data to evaluate which microphones are actively capturing speech. If multiple devices report similar amplitude levels, the voice recognition unit 540 may further analyze the received data to determine speaker identity and recognition confidence.

In some examples, at block 930, the wireless communication device 510 populates a microphone amplitude array using the received microphone-related information from participating devices. The microphone amplitude array dynamically ranks microphones based on amplitude strength and, in some examples, speaker recognition accuracy and background noise levels. As an example, the microphone management module 530 processes the received microphone-related information to determine which microphone should be prioritized. If the communication device 505 transmits higher amplitude levels and high speaker recognition confidence, it is prioritized in the microphone amplitude array for audio transmission. Conversely, devices with low amplitude levels or high background noise are deprioritized.

In some examples, at block 940, the wireless communication device determines whether the microphone-related information from a participating device meets a predefined recognition threshold. As an example, the voice recognition unit 540 analyzes the confidence scores associated with the detected voices to verify whether they match a known speaker profile. If the microphone-related information exceeds the recognition threshold, meaning the detected voice is highly confident and intelligible, the wireless communication device proceeds to block 940, where the wireless communication device grants channel access to the device. If the microphone-related information does not exceed the recognition threshold, meaning the speaker is unrecognized or confidence is low, the wireless communication device moves to block 950, where the wireless communication device reduces microphone sensitivity.

In some examples, at block 950, the wireless communication device reduces the microphone sensitivity of a participating device if its voice recognition confidence score falls below the predefined recognition threshold. As an example, the microphone management module 530 and noise cancellation module 560 work together to suppress unintended voices and background noise. If a device detects ambient noise, the noise cancellation module 560 may reduce its microphone sensitivity to filter out distractions. If a device transmits low-confidence speech data, the microphone management module 530 may attenuate its microphone to prevent overlapping transmissions. After adjusting the microphone sensitivity, the wireless communication device can return to block 910 to continue monitoring microphone-related information.

In some examples, at block 960, the wireless communication device grants audio channel access to the participating device that has met or exceeded the recognition threshold. As an example, the microphone management module 530 updates the microphone amplitude array to reflect the new selection, and the communication session application 515 facilitates the real-time transmission of the selected microphone’s audio data. If a device reports the highest amplitude level and high speaker recognition confidence, the wireless communication device prioritizes it for audio transmission. Other devices in the session are instructed to reduce their microphone sensitivity, ensuring that the selected microphone is used. Once the microphone selection is updated, the wireless communication device returns to block 910 to continuously listen for new microphone-related updates.

FIG. 10 shows an example block diagram of an example wireless communication device 1000 that supports microphone selection between participating devices in a communication session using amplitude-based selection and speaker recognition to select the microphone. In some examples, the wireless communication device 1000 is configured to perform the processes 700, 800, and 900 described, respectively, with reference to FIGS. 7-9. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1000 may transmit the information output from the chip. In such an example, the second interface may refer to an interface between the processing system of the chip and a reception component, such that the device 1000 may receive information that is passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a STA, such as the STA 104 described with reference to FIG. 1. In some other examples, the wireless communication device 1000 can be a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes various components 1005. The components 1005 may include a communication session application 515, a microphone management module 530, a voice recognition unit 540, a device synchronization component 550, a noise cancellation module 560, and a database 570. Portions of one or more of the 1005 components may be implemented at least in part in hardware or firmware. For example, the microphone management module 530 may be implemented at least in part by a processor or a modem. In some examples, portions of one or more of the components 1005 may be implemented at least in part by a processor and software in the form of processor-executable code stored in a memory.

The microphone management module 530 is configurable or configured to receive microphone-related information from participating devices in a communication session. The microphone-related information includes voice amplitude levels, voice recognition confidence scores, and device microphone IDs. The microphone management module 530 is configurable or configured to process the microphone-related information and update a microphone-amplitude array that maintains a ranked list of microphones based on their audio clarity and recognition accuracy. The microphone management module 530 is further configurable or configured to determine an optimal microphone for audio transmission based on the microphone-related information and adjust microphone sensitivity levels dynamically. The microphone management module 530 is also configurable or configured to suppress lower-ranked microphones to minimize cross-talk and overlapping speech.

The voice recognition unit 540 is configurable or configured to analyze incoming voice data from participating devices to determine speaker identity and recognition accuracy. The voice recognition unit 540 is further configurable or configured to assign a confidence score to detected voices based on a comparison with stored voice models. The voice recognition unit 540 is configurable or configured to transmit the recognition confidence score alongside the detected microphone amplitude levels, allowing the application 515 to prioritize microphones capturing recognized speakers. The voice recognition unit 540 is also configurable or configured to filter out unintended voices by lowering the sensitivity or disabling microphones with low recognition accuracy. In a decentralized communication session, the voice recognition unit 540 is configurable or configured to allow devices to compare voice recognition scores against those reported by other devices in the session.

The device synchronization component 550 is configurable or configured to manage a random-access timer (RA Timer) so that microphone-related updates occur at appropriate intervals, preventing rapid or redundant microphone switching. The device synchronization component 550 is further configurable or configured to synchronize microphone selection decisions across the participating communication devices, allowing every device in the communication session to operate with an updated microphone-amplitude array. The device synchronization component 550 is also configurable or configured to coordinate real-time microphone updates in both centralized and decentralized communication sessions. In a centralized configuration, the device synchronization component 550 is configurable or configured to relay microphone state updates from a primary wireless communication device to the participating devices. In a decentralized configuration, the device synchronization component 550 is configurable or configured to allow participating devices to independently synchronize microphone-related information through periodic broadcasting.

The noise cancellation module 560 is configurable or configured to apply active noise cancellation (ANC) techniques to enhance speech clarity and reduce background noise during a communication session. The noise cancellation module 560 is further configurable or configured to analyze incoming audio signals and dynamically adjust microphone sensitivity based on detected noise levels. The noise cancellation module 560 is configurable or configured to integrate beamforming, spectral subtraction, and machine learning-based noise filtering so that speech signals are amplified, while non-speech sounds such as typing, background conversations, or environmental noise are suppressed. The noise cancellation module 560 is also configurable or configured to collaborate with the microphone management module 530 to switch to an alternative microphone with a higher signal-to-noise ratio (SNR) if excessive background noise is detected. Additionally, the noise cancellation module 560 is configurable or configured to implement far-field voice detection techniques that prioritize the primary speaker's voice while mitigating background disturbances.

The microphone amplitude array database 570 is configurable or configured to store real-time microphone amplitude levels and voice recognition accuracy scores from participating devices in a communication session. The microphone amplitude array database 570 is further configurable or configured to maintain a continuously updated record of microphone performance rankings, allowing the application 515 to select the best microphone for audio transmission. In a centralized communication session, the microphone amplitude array database 570 is configurable or configured to serve as the primary reference for microphone selection decisions, while in a decentralized system, it is configurable or configured to enable each device to maintain and update its own local copy of the microphone rankings.

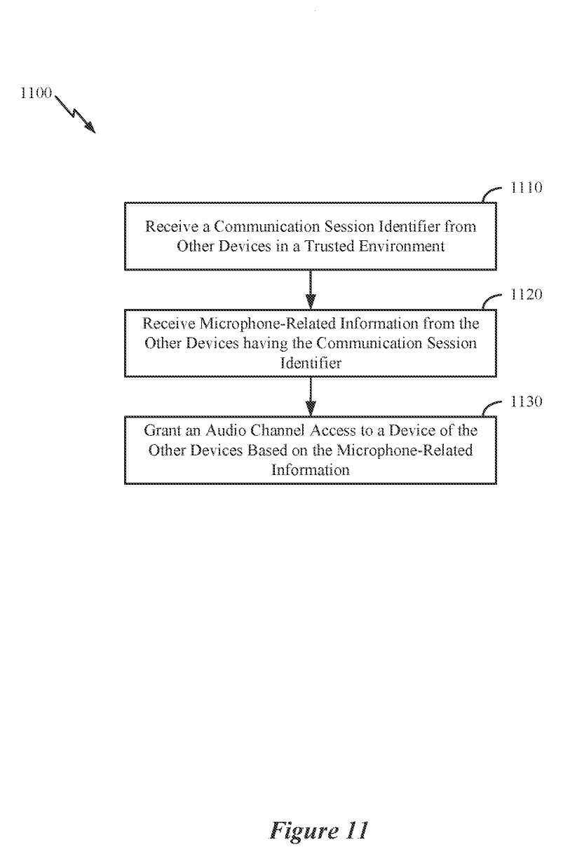

FIG. 11 illustrates an example flowchart depicting an example process 1100 performable by or at a wireless communication device that supports dynamically managing microphone selection in a centralized communication session. The operations of the process 1100 may be implemented by a wireless communication device or its components as described herein. For example, the process 1100 may be performed by a wireless communication device, such as the wireless communication device 1000 described with reference to FIG. 10, operating within a wireless AP, a wireless STA or other wireless communication device. In some examples, the process 1100 may be performed by a wireless AP, such as one of the APs 102, or the wireless STA, such as one of the STAs 104 described with reference to FIG. 1. In some examples, the process 1100 also may be performed by a wireless communication device such as the wireless communication device 510 with reference to FIG. 5.

In some examples, at block 1110, the wireless communication device receives a communication session identifier from one or more other devices operating in a trusted environment. The session identifier may be generated by a secure device service or communication session application and transmitted to participating devices to establish a coordinated and secure session. Upon receiving the identifier, the wireless communication device may authenticate the participating devices, confirming that they are part of the same session. The communication session identifier can act as a token to distinguish the communication session from other active sessions and may ensure that microphone selection and channel access decisions are made among devices recognized within the shared context.

In some examples, at block 1120, the wireless communication device receives microphone-related information from the other devices in the trusted environment that are associated with the same session identifier. The microphone-related information may include real-time audio amplitude levels detected by each device’s microphone and, in some examples, with voice recognition confidence scores generated by speaker identification models. The information may be provided, updated periodically, and securely exchanged using encrypted channels. The wireless communication device, upon receiving this information, may store and process it using an internal microphone-amplitude array, similar to the array described with reference to FIG. 6, which ranks devices according to audio clarity and speaker confidence.

In some examples, at block 1130, the wireless communication device grants audio channel access to one of the devices based on the received microphone-related information. The device may apply a prioritization algorithm that considers microphone amplitude and, in some examples, voice recognition percentage, granting access to the device that is most likely to be capturing the primary speaker. For example, if one device reports a significantly higher amplitude level and a high recognition confidence score, it may be selected to transmit audio while others are attenuated or suppressed. The wireless communication device may also send instructions to non-selected devices to reduce their microphone sensitivity or temporarily disable audio transmission, thereby minimizing background noise and preventing overlapping speech. The coordinated audio channel management improves meeting clarity in multi-device environments, ensuring that only the most relevant audio is transmitted at any given time.

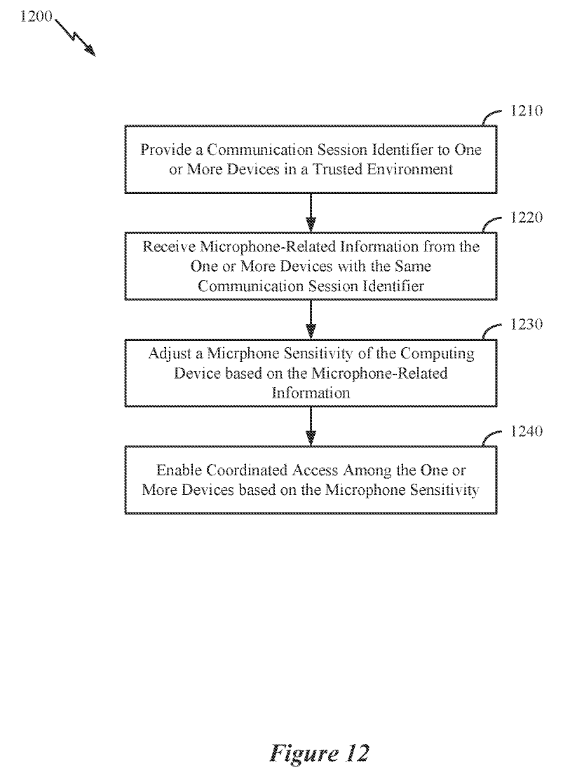

FIG. 12 illustrates an example flowchart depicting an example process 1200 performable by or at a wireless communication device that supports dynamically managing microphone selection in a decentralized communication session. The operations of the process 1200 may be implemented by a wireless communication device or its components as described herein. For example, the process 1200 may be performed by a wireless communication device, such as the wireless communication device 1000 described with reference to FIG. 10, operating within a wireless AP, a wireless STA or other wireless communication device. In some examples, the process 1200 may be performed by a wireless AP, such as one of the APs 102, or the wireless STA, such as one of the STAs 104 described with reference to FIG. 1. In some examples, the process 1200 also may be performed by a wireless communication device such as the wireless communication device 510 with reference to FIG. 5.

In some examples, at block 1210, the wireless communication device provides a communication session identifier to one or more participating devices in a trusted environment. This session identifier enables the wireless communication device and the participating devices to associate themselves with a common communication session. The identifier may be generated by a communication session application (such as application 515) and disseminated using secure broadcast or signaling protocols within the trusted environment. Devices that receive and recognize this identifier can authenticate their participation and begin synchronized communication activities, including contributing microphone-related information and receiving configuration updates from a centralized device.

In some examples, at block 1220, the wireless communication device receives microphone-related information from the participating devices that share the same communication session identifier. The microphone-related information may include parameters such as voice amplitude, device and microphone identifiers, and voice recognition confidence scores, which may be calculated by each device’s voice recognition unit (such as unit 540). The wireless communication device can collect and store this data in an internal microphone-amplitude array, which can be used to analyze current speaking activity and assess which device is best positioned to capture speech.

In some examples, at block 1230, the wireless communication device adjusts its own microphone sensitivity based on the microphone-related information received from the other devices. As an example, if another device reports a higher amplitude and voice recognition score than the local device, the wireless communication device may attenuate its microphone sensitivity to reduce crosstalk or background interference. Conversely, if no other device has a better profile, the device may maintain or raise its own sensitivity to prepare for potential speech transmission. In some examples, the sensitivity adjustment may be further influenced by factors such as a predefined attenuation threshold or a hysteresis value to avoid frequent toggling. In some implementations, the wireless communication device also applies local noise cancellation techniques, including beamforming and active noise suppression, to refine its microphone’s output signal.

In some examples, at block 1240, the wireless communication device enables coordinated access among the participating devices based on the adjusted microphone sensitivities. This coordination provides that only one device transmits audio at a time, typically the device with the highest-ranked microphone based on amplitude and, in some examples, recognition accuracy, while other devices reduce their microphone sensitivity or defer transmission altogether. In some examples, the coordination may be governed by a time-based arbitration mechanism or round-robin protocol to minimize collisions and promote fairness in multi-user environments. The result is a dynamically adaptive and seamless audio experience across a multi-device communication session, enhancing overall speech clarity while suppressing background noise and unintentional transmissions.

Implementation examples are described in the following numbered clauses:

Clause 1. A computing device in a trusted environment, including: a processing system that includes one or more processors and one or more memories coupled with the one or more processors, the processing system configured to cause the computing device to: receive a communication session identifier from other devices in a trusted environment, receive microphone-related information from the other devices having the communication session identifier in the trusted environment, and grant an audio channel access to a device of the other devices based on the microphone-related information.

Clause 2. The computing device of clause 1, where the processing system is further configured to cause the computing device to: receive the microphone-related information including a voice recognition percentage from at least one of the other devices, and grant the audio channel access to the device based on the microphone-related information including the voice recognition percentage.

Clause 3. The computing device of any of clauses 1-2, where the voice recognition percentage indicates a confidence score associated with speech known to the at least one of the other devices.

Clause 4. The computing device of any of clauses 1-3, where granting the audio channel access to the device is based on a highest microphone amplitude and a highest voice recognition percentage associated with the microphone-related information.

Clause 5. The computing device of any of clauses 1-4, where the processing system is further configured to cause the computing device to: provide a request to at least one of the other devices to reduce a microphone sensitivity based on the microphone-related information associated with the at least one of the other devices being below a threshold.

Clause 6. The computing device of any of clauses 1-5, where the processing system is further configured to cause the computing device to provide a request to the other devices to apply noise cancellation techniques, including far-field voice filtering and suppression of non-speech audio, before providing audio data.

Clause 7. The computing device of any of clauses 1-6, where the processing system is further configured to cause the computing device to adjust microphone sensitivity levels of the other devices based on a predefined attenuation threshold, where microphones with an amplitude level below the threshold have their corresponding microphone sensitivity reduced to reduce background noise.

Clause 8. The computing device of any of clauses 1-7, where the processing system is further configured to cause the computing device to prioritize granting audio channel access based on a combination of detected microphone amplitude and a voice recognition confidence score associated with the microphone-related information.

Clause 9. The computing device of any of clauses 1-8, where the processing system is further configured to cause the computing device to apply an attenuation threshold to the received microphone-related information such that microphones with amplitude levels below the attenuation threshold have their corresponding microphone sensitivity reduced.

Clause 10. The computing device of any of clauses 1-9, where the processing system is further configured to cause the computing device to update a microphone-amplitude array that maintains rankings of the other devices based on real-time microphone amplitude and voice recognition accuracy.

Clause 11. A computing device in a trusted environment, including: a processing system that includes one or more processors and one or more memories coupled with the one or more processors, the processing system configured to cause the computing device to: provide a communication session identifier to one or more devices in a trusted environment, receive microphone-related information from the one or more devices with the same communication session identifier, adjust a microphone sensitivity of the computing device based on the microphone-related information, and enable coordinated access among the one or more devices based on the microphone sensitivity.

Clause 12. The computing device of clause 11, where the computing device receives the microphone-related information in a round-robin manner to synchronize microphone sensitivities among the one or more devices.

Clause 13. The computing device of any of clauses 11-12, where the processing system is further configured to cause the computing device to: apply an attenuation that prevents audio transmission when internal microphone-related information associated with the computing device is below a threshold level, and increase the attenuation when the one or more devices causes an increase in the internal microphone-related information while providing audio.

Clause 14. The computing device of any of clauses 11-13, where the processing system is further configured to cause the computing device to: reduce the microphone sensitivity based on internal microphone-related information associated with the computing device and the microphone-related information exceeding a speaking threshold and the microphone-related information having a higher amplitude than the internal microphone-related information.

Clause 15. The computing device of any of clauses 11-14, where the processing system is further configured to cause the computing device to apply local noise cancellation techniques, including active noise cancellation (ANC) and beamforming, to suppress unintended audio capture from other microphones.

Clause 16. The computing device of any of clauses 11-15, where the processing system is further configured to cause the computing device to: receive the microphone-related information including a voice recognition percentage associated with the one or more devices, where the recognition percentage indicates a confidence score associated with speech known to the computing device, and adjust the microphone sensitivity based on the microphone-related information including the voice recognition percentage.

Clause 17. The computing device of any of clauses 11-16, where the processing system is further configured to cause the computing device to provide an instruction to at least one of the one or more devices to adjust its microphone sensitivity based on detected changes in voice amplitude or speaker recognition accuracy.

Clause 18. The computing device of any of clauses 11-17, where the processing system is further configured to cause the computing device to apply active noise suppression techniques during the communication session.

Clause 19. The computing device of any of clauses 11-18, where the processing system is further configured to cause the computing device to synchronize microphone sensitivity levels among the one or more devices using a time-based arbitration mechanism.

Clause 20. An application client device, including: a processing system that includes one or more processors and one or more memories coupled with the one or more processors, the processing system configured to cause the application client device to: receive a communication session identifier from other devices in a trusted environment, receive microphone-related information from the other devices having the communication session identifier in the trusted environment, and grant an audio channel access to a device of the other devices based on the microphone-related information.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A computing device in a trusted environment, comprising:
a processing system that includes one or more processors and one or more memories coupled with the one or more processors, the processing system configured to cause the computing device to:
receive a communication session identifier from other devices in a trusted environment;
receive microphone-related information from the other devices having the communication session identifier in the trusted environment; and
grant an audio channel access to a device of the other devices based on the microphone-related information.

2. The computing device of claim 1, wherein the processing system is further configured to cause the computing device to:
receive the microphone-related information including a voice recognition percentage from at least one of the other devices; and
grant the audio channel access to the device based on the microphone-related information including the voice recognition percentage.

3. The computing device of claim 2, wherein the voice recognition percentage indicates a confidence score associated with speech known to the at least one of the other devices.

4. The computing device of claim 3, wherein granting the audio channel access to the device is based on a highest microphone amplitude and a highest voice recognition percentage associated with the microphone-related information.

5. The computing device of claim 3, wherein the processing system is further configured to cause the computing device to:
provide a request to at least one of the other devices to reduce a microphone sensitivity based on the microphone-related information associated with the at least one of the other devices being below a threshold.

6. The computing device of claim 1, wherein the processing system is further configured to cause the computing device to provide a request to the other devices to apply noise cancellation techniques, including far-field voice filtering and suppression of non-speech audio, before providing audio data.

7. The computing device of claim 1, wherein the processing system is further configured to cause the computing device to adjust microphone sensitivity levels of the other devices based on a predefined attenuation threshold, wherein microphones with an amplitude level below the threshold have their corresponding microphone sensitivity reduced to reduce background noise.

8. The computing device of claim 1, wherein the processing system is further configured to cause the computing device to prioritize granting audio channel access based on a combination of detected microphone amplitude and a voice recognition confidence score associated with the microphone-related information.

9. The computing device of claim 1, wherein the processing system is further configured to cause the computing device to apply an attenuation threshold to the received microphone-related information such that microphones with amplitude levels below the attenuation threshold have their corresponding microphone sensitivity reduced.

10. The computing device of claim 1, wherein the processing system is further configured to cause the computing device to update a microphone-amplitude array that maintains rankings of the other devices based on real-time microphone amplitude and voice recognition accuracy.

11. A computing device in a trusted environment, comprising:
a processing system that includes one or more processors and one or more memories coupled with the one or more processors, the processing system configured to cause the computing device to:
provide a communication session identifier to one or more devices in a trusted environment;
receive microphone-related information from the one or more devices with the same communication session identifier;
adjust a microphone sensitivity of the computing device based on the microphone-related information; and
enable coordinated access among the one or more devices based on the microphone sensitivity.

12. The computing device of claim 11, wherein the computing device receives the microphone-related information in a round-robin manner to synchronize microphone sensitivities among the one or more devices.

13. The computing device of claim 11, wherein the processing system is further configured to cause the computing device to:
apply an attenuation that prevents audio transmission when internal microphone-related information associated with the computing device is below a threshold level; and
increase the attenuation when the one or more devices causes an increase in the internal microphone-related information while providing audio.

14. The computing device of claim 11, wherein the processing system is further configured to cause the computing device to:
reduce the microphone sensitivity based on internal microphone-related information associated with the computing device and the microphone-related information exceeding a speaking threshold and the microphone-related information having a higher amplitude than the internal microphone-related information.

15. The computing device of claim 11, wherein the processing system is further configured to cause the computing device to apply local noise cancellation techniques, including active noise cancellation (ANC) and beamforming, to suppress unintended audio capture from other microphones.

16. The computing device of claim 11, wherein the processing system is further configured to cause the computing device to:
receive the microphone-related information including a voice recognition percentage associated with the one or more devices, wherein the recognition percentage indicates a confidence score associated with speech known to the computing device; and
adjust the microphone sensitivity based on the microphone-related information including the voice recognition percentage.

17. The computing device of claim 11, wherein the processing system is further configured to cause the computing device to provide an instruction to at least one of the one or more devices to adjust its microphone sensitivity based on detected changes in voice amplitude or speaker recognition accuracy.

18. The computing device of claim 11, wherein the processing system is further configured to cause the computing device to apply active noise suppression techniques during the communication session.

19. The computing device of claim 11, wherein the processing system is further configured to cause the computing device to synchronize microphone sensitivity levels among the one or more devices using a time-based arbitration mechanism.

20. An application client device, comprising:
a processing system that includes one or more processors and one or more memories coupled with the one or more processors, the processing system configured to cause the application client device to:
receive a communication session identifier from other devices in a trusted environment;
receive microphone-related information from the other devices having the communication session identifier in the trusted environment; and
grant an audio channel access to a device of the other devices based on the microphone-related information.
